(19) United States
(12) Patent Application Publication
(10) Pub. No.: US 2016/0307227 A1
(43) Pub. Date: Oct. 20, 2016

(54) PASSING OBSERVER SENSITIVE PUBLICATION SYSTEMS

(71) Applicant: eBay Inc., San Jose, CA (US)

(72) Inventor: Christopher Li, Bellevue, WA (US)

(21) Appl. No.: 14/685,906

(22) Filed: Apr. 14, 2015

(51) Int. Cl. G06Q 30/02

(52) U.S. Cl. CPC G06Q 30/0242; G06Q 30/0261

(57) ABSTRACT

A content publication device includes motion/speed sensors to detect a position/speed of a passing observer in the vicinity. A content selector module selects targeted content for publication by the content publication device based on the detected position/speed of the passing observer. An observer reaction module determines whether the selected content has caused a reaction in the passing observer based on motion/speed sensor data. The reaction might be the passing observer moving towards the content publication device or moving more slowly away from the content publication device. A first kiosk or billboard advertisement may be displayed based on a first detected position/speed of the passing observer and a second kiosk or billboard advertisement, providing more billboard details or options for interacting with the kiosk, may be displayed based on a second detected position/speed of the passing observer, a predicted position of the passing observer or a reaction of the passing observer.

### FIELD

The present disclosure relates generally to publication systems and the presentation of content. More specifically, the present disclosure describes publication systems that sense the relative position or location of a detected passing observer and provide content that is based on the detected position or location of the passing observer.

### BACKGROUND

Publication systems can be used to present content. Content, such as targeted information, may take many forms. Content may be targeted at viewers/listeners in the context of a product or service being offered by a business entity and may include a wide range of media such as newspaper, magazines, television, radio, direct mail, websites or even text messages. Large public content publication systems like billboards and store/kiosk fronts are designed to be consumed by multiple passing viewers/listeners.

### BRIEF DESCRIPTION OF DRAWINGS

Various ones of the appended drawings merely illustrate example embodiments of the present invention and cannot be considered as limiting its scope.

FIG. 1 is a block diagram illustrating an example embodiment of network architecture for interaction between a content publication device and a passing observer in an open public viewing/listening environment.

FIG. 2 is a block diagram illustrating multiple components that, in one embodiment, are provided within a publication system operable over a network.

FIG. 3 is a block diagram illustrating multiple components that, in one embodiment, are provided within an interaction system operable over a network.

FIGS. 4A and 4B illustrate an example embodiment of a client device comprising a kiosk attempting to grab the attention of a passing observer.

FIGS. 5A and 5B illustrate an example embodiment of a client device comprising a kiosk attempting to grab the attention of a passing observer.

FIG. 6A illustrates an example embodiment of a client device comprising a billboard attempting to grab the attention of a passing observer.

FIG. 6B illustrates an example embodiment of a client device comprising a billboard attempting to grab the attention of a passing observer.

FIG. 7 is a flow diagram of an example high-level method for interaction between a content publication device and a passing observer in an open public viewing/listening environment.

FIG. 8 is a flow diagram of an example high-level method for interaction between a content publication device and a passing observer in an open public viewing/listening environment.

FIG. 9 is a simplified block diagram of a machine in an example form of a computing system within which a set of instructions for causing the machine to perform any one or more of the methodologies discussed herein may be executed.

FIG. 10 is a simplified block diagram of a mobile device for use with any one or more of the methodologies discussed herein.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

As used herein, the term “or” may be construed in either an inclusive or exclusive sense. Additionally, although various example embodiments discussed below focus on a marketplace environment, the embodiments are given merely for clarity in disclosure. Thus, any type of electronic publication, electronic commerce, social networking, or electronic business system and method, including various system architectures, may employ various embodiments of the system and method described herein and may be considered as being within a scope of example embodiments. Each of a variety of example embodiments is discussed in detail below.

Interface—For the purposes of this specification and the associated claims, the term “interface” includes any interface that can convey information to a user or receive information from a user. An interface may be associated with a billboard or advertising kiosk, as described in some examples below, or it may not. An interface can exist in many forms. For example, the interface may interact with a user, in a functional or physical way, and may contribute and/or consume content. The interface may or may not be associated with a device. The interface may be mouse driven, voice driven, or touch driven, for example. An associated device may or may not be network enabled. The device or interface may be associated with local or proximate processing capability. In some examples, a physical interface may be presented by “smart” glasses (for example, Google glasses). In other embodiments, an interface may be intangible, such as a hologram. In further examples, the interface may be a non-mobile surface, such as a wall, a table-top, or a side of an appliance or building. In other examples, an interface may be provided in a smart kiosk, or by a surface or device inside a motor vehicle, for example.

Targeted information—For the purposes of this specification and the associated claims, the term “targeted information” includes consumable information or non-consumable information (for example, metadata). Consumable examples can be displayed, emailed, pushed, or included in a text message. The information may include tiles, social media, digital data, physical (billboard) embodiments, audio files, commercial art, smart advertisements and so forth. In some examples, targeted information may include “ad content” or an “advertisement.” The information may be targeted in that it is presented to a detected passing observer based on the passing observer's position relative to a content publication device or interface.

Ad content, or advertisement—For the purposes of this specification and the associated claims, the term “ad content” or “advertisement” includes promotional information. A promotion in ad content or advertisement need not be tied to commerce, or payment, or a transaction, but will usually be associated with receipt of some kind of value. The value could relate to a good or a service (or hybrid of same).

Billboards may be used for public advertisements that typically consist of a combination of texts and images. Billboards generally are used for large advertisements placed in areas where large quantities of passing observers can view/consume them. However, the typically static nature of a billboard does not allow it to distinguish between a passing observer in a first position and a passing observer in a second position for the purpose of presenting advertisements. The same can be said about kiosks (and other interactive systems) installed in retail stores and in the case of kiosks this often results in a failure to attract passing observers to use the kiosk. A kiosk may rely on inviting imagery on its housing or loops of video graphics and/or sound to attract passing observers. However, the customer acquisition rate of such a kiosk that is not sensitive to the position and movement of a passing observer may be unacceptably low if the kiosk is designated for advertising.

Example embodiments described herein provide systems and methods for interaction between passing observers and a content publication device in an open visual/audio media viewing environment such as a lobby, a plaza, a roadside or other large open space that may incur large amounts of human traffic. A content publication device may include an electronic display, a microphone and speakers, and motion sensors and/or speed sensors to detect a position and/or speed of a passing observer in a specified vicinity of the device. In some examples, the content publication device includes a passive interface included in the definition provided above. A content selector module (e.g., located at the content publication device or remotely connected) selects targeted content (e.g., an advertisement) for publication (e.g. display of images emission of sounds) by the content publication device based on the detected position of the passing observer. For example, if the passing observer is detected at a first position outside of a threshold distance from the content publication device, then attention grabbing targeted content with flashing images and/or inviting sounds (e.g., an audio greeting or invitation) may be published. If the passing observer is detected at a closer second position inside of the threshold distance from the content publication device, then more detailed targeted content is published for interaction with an interested passing observer.

An observer reaction module (e.g., located at the content publication device or remotely connected) may determine whether the selected attention grabbing targeted content has caused a reaction by the passing observer (e.g., grabbed the passing observer's attention) based on data from the motion sensor and/or the speed sensor. The possible determined reactions might include: the passing observer gets closer, e.g., moves towards the content publication device; the passing observer lingers, e.g., remains still (e.g., little or no movement and/or speed) in a specified vicinity of the device; or the passing observer acknowledges the targeted content, e.g., move more slowly away from the device. The content publication device may be configured to ignore sensor data regarding other detected passing observers during the time that it is engaged in attempting to attract the attention of the initial detected passing observer.

In example embodiments, the content publication device may be a kiosk or a billboard used for publishing targeted content designed to attract customers. In an embodiment with a content publication device comprising a kiosk, the content selector module may be configured to select first targeted content (e.g., standard kiosk advertisement) based on a first detected position of the passing observer (e.g., if the passing observer is detected within a specified vicinity of the kiosk) and to select more aggressive second targeted content including flashing images and sounds based on a determination that the first targeted content did not cause a reaction from the passing observer. The second targeted content may be more detailed than the first targeted content, for example, by including options for interacting with the kiosk, such as shopping or messaging.

In an embodiment, the content publication device comprises a billboard and the content selector module may be configured to select a first billboard advertisement (e.g., advertisement with a small number of large images and/or text) based on a first detected position of the passing observer (e.g., if the passing observer is detected beyond a threshold distance from the billboard) and to select a second billboard advertisement that provides more details (e.g., advertisement with a larger number of smaller images and/or text) based on a second detected position of the passing observer that is closer to the content publication device (e.g., if the passing observer is detected within the threshold distance from the billboard) than the first detected position of the passing observer.

In an embodiment, the threshold distance from the billboard may be based on the ability of a standard human being to discern images and text at a distance. For example, the first billboard advertisement may include larger images and text to attract the passing observer at a distance and the second billboard advertisement can provide more details by making use of more numerous smaller images and text that are too small to be understood/discerned from the first detected position of the passing observer but large enough to be understood/discerned from the second detected position of the passing observer.

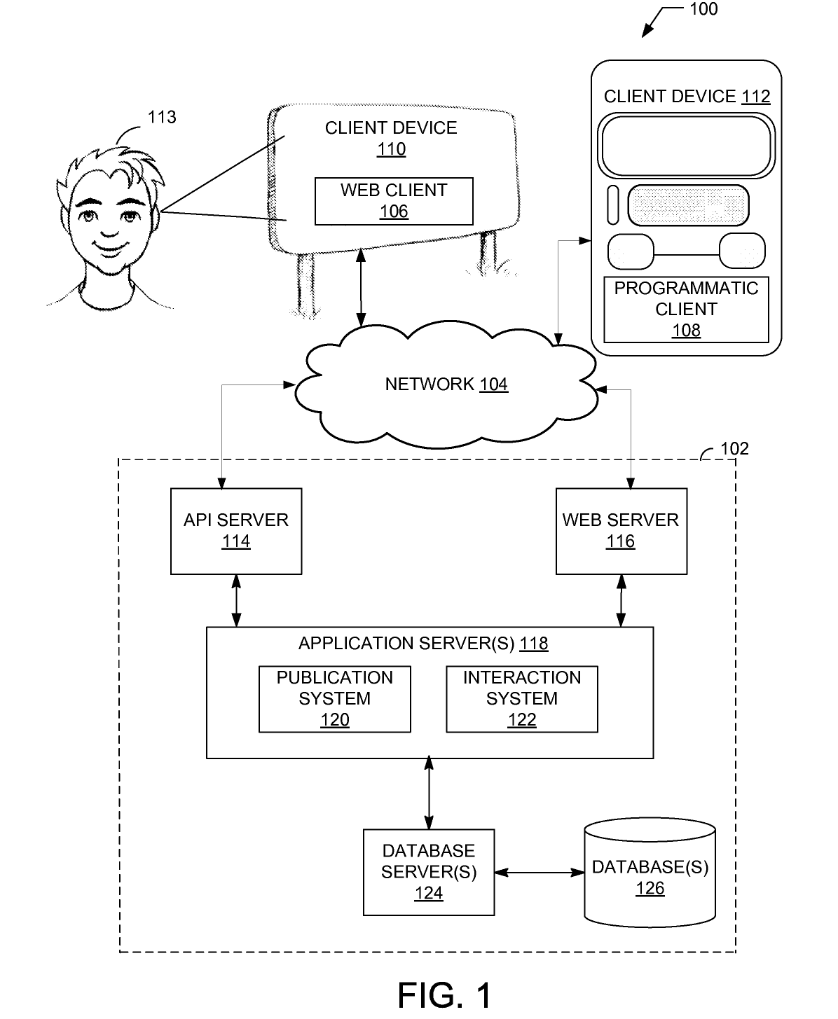

FIG. 1 is a block diagram illustrating an example embodiment of network architecture 100 for interaction between a content publication device (e.g., client device 110 and client device 112) and a passing observer 113 in an open public viewing/listening environment. A networked system 102, in an example form of a network-server-side functionality, is coupled via a communication network 104 (e.g., the Internet, wireless network, cellular network, or a Wide Area Network (WAN)) to one or more client devices 110 and 112. FIG. 1 illustrates, for example, a web client 106 operating via a browser (e.g., such as the INTERNET EXPLORER® browser developed by Microsoft® Corporation of Redmond, Wash. State), and a programmatic client 108 executing on respective client devices 110 and 112.

The client device 110 and client device 112 may comprise a billboard (e.g., client device 110), a kiosk (e.g., client device 112) or any other kind of public content publication device that a passing observer 113 may view in an open environment such as a lobby, a plaza or along a roadside that is visible to large amounts of traffic. In embodiments, the client device 110 and client device 112 may comprise one or more of a motion sensor, speed sensor, camera, projector, touch screen, keyboard, accelerometer, microphone, and GPS device. The client devices 110 and 112 may each be a content publication device of a user or business interested in attracting new customers.

An Application Program Interface (API) server 114 and a web server 116 are coupled to, and provide programmatic and web interfaces respectively to, one or more application servers 118. The application servers 118 host a publication system 120 and a interaction system 122, each of which may comprise one or more modules, applications, or engines, and each of which may be embodied as hardware, software, firmware, or any combination thereof. The application servers 118 are, in turn, coupled to one or more database servers 124 facilitating access to one or more information storage repositories or database(s) 126. The databases 126 may also store user account information of the networked system 102 in accordance with example embodiments.

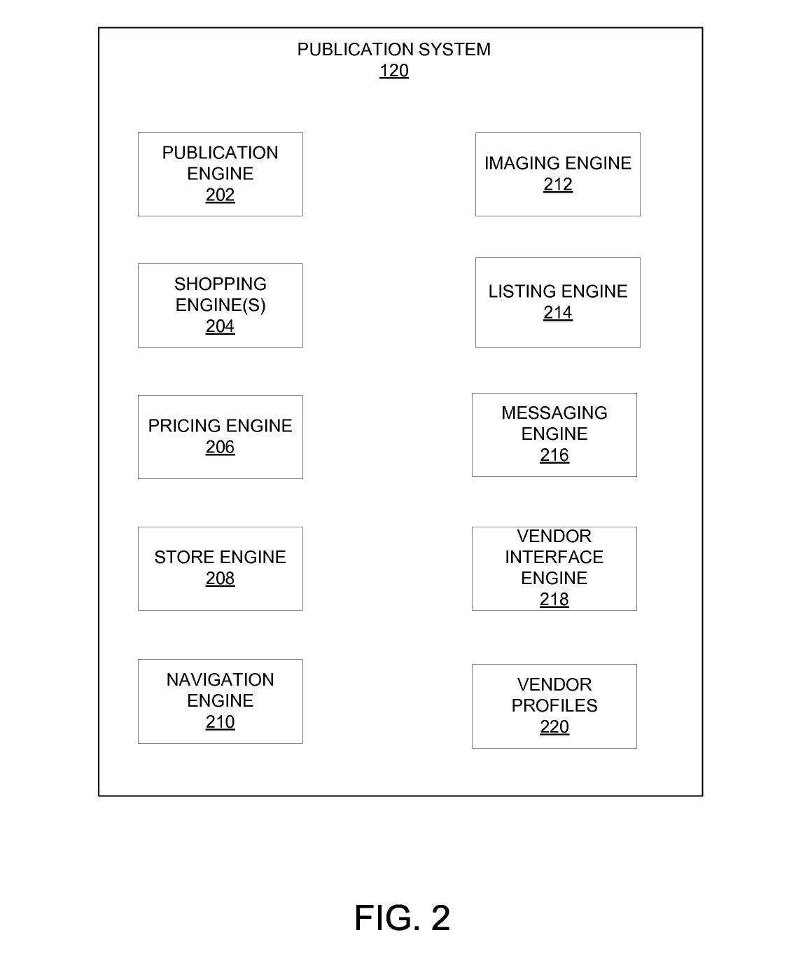

In example embodiments, the publication system 120 publishes content (e.g., advertisements) on a network 104 such as the Internet. As such, the publication system 120 provides a number of publication functions and services to client devices that access the networked system 102. The publication system 120 is discussed in more detail in connection with FIG. 2. In example embodiments, the publication system 120 is discussed in terms of a marketplace environment. However, it is noted that the publication system 120 may be associated with a non-marketplace environment such as an informational or social networking environment. Furthermore, in the context of the present disclosure the publication system 120 may provide images, sounds and information regarding vendors and their merchandise (e.g., in the form of advertisements and listings) to client devices 110 and 112 via the network 104.

The interaction system 122 provides a number of interactive services and functions with regard to a passing observer 113. The interaction system 122 allows client devices 110 and 112 to publish content (e.g., display advertisements) that is sensitive to the surroundings by analyzing data from sensors of the client devices 110 and 112. The interaction system 122 may also receive, interpret and react to input from passing observer 113 via a user interface provided by a client device 112 in the form of a kiosk. The interaction system 122 also facilitates payments from a payment mechanism (e.g., a bank account, PayPal™, or credit card) for purchases of items via any type and form of a network-based marketplace accessible via network 104. For example, in the context of the present disclosure the interaction system 122 may facilitate payment to vendors via client device 112 in the form of a kiosk.

While the publication system 120 and the interaction system 122 are shown in FIG. 1 to both form part of the networked system 102, it will be appreciated that, in alternative embodiments, the interaction system 122 may form part of a payment service that is separate and distinct from the networked system 102. Additionally, while the example network architecture 100 of FIG. 1 employs client-server architecture, a skilled artisan will recognize that the present disclosure is not limited to such architecture. The example network architecture 100 can equally well find application in, for example, a distributed or peer-to-peer architecture system. The publication system 120 and interaction system 122 may also be implemented as standalone systems or standalone software programs operating under separate hardware platforms, which do not necessarily have networking capabilities (e.g., in client device 110 or client device 112).

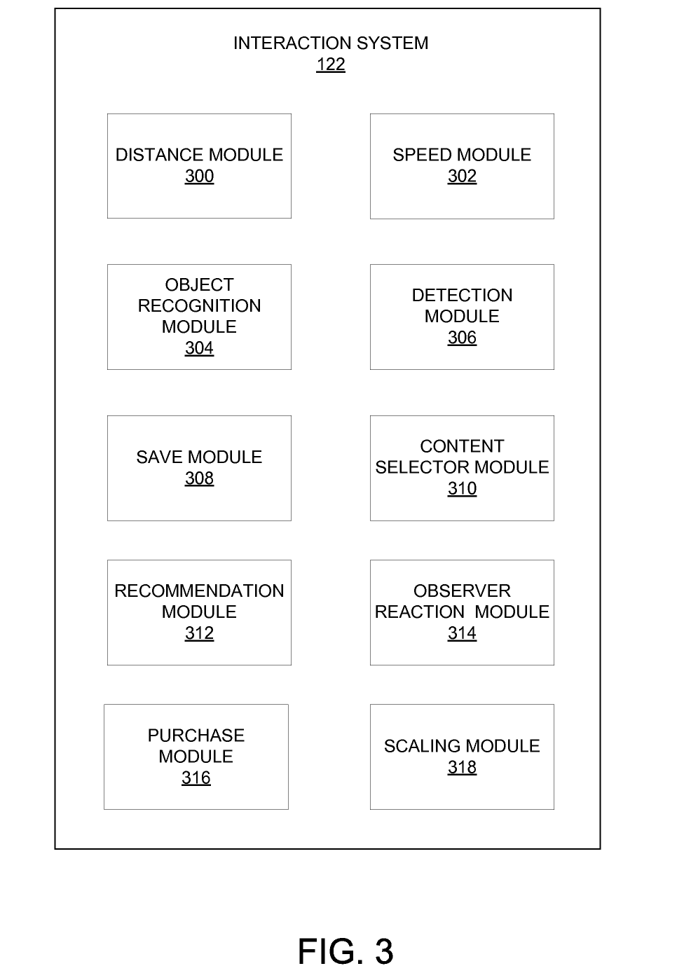

A content publication device in the form of client device 110 or 112 may include an electronic display and speakers for publishing targeted content; a user interface and microphone for interacting with passing observer 113; and motion sensors and/or speed sensors to detect a position and/or speed of passing observer 113 in a specified vicinity of the client device 110 or 112. A content selector module (e.g., located at the client device 110 or 112 or remotely connected from the interaction system 122) selects targeted content for publication by the client device 110 or 112 based on the detected position of the passing observer 113. For example, if the passing observer 113 is detected at a first position outside of a threshold distance (e.g., 3 feet) from the client device 110 or 112, then attention grabbing first targeted content (e.g., an audio/visual greeting or invitation) may be published by the client device 110 or 112. If the passing observer 113 is detected at a closer second position (e.g., inside of the threshold distance from the client device 110 or 112), then more detailed second targeted content is published by the client device 110 or 112 for interaction with a seemingly interested passing observer 113. An observer reaction module (e.g., located at the client device 110 or 112 or remotely connected from the interaction system 122) may determine whether the first targeted content has caused a reaction by the passing observer 113 (e.g., grabbed the attention of passing observer 113) based on data from the motion sensor and/or the speed sensor of the client device 110 or 112. The possible determined reactions might include: the passing observer 113 gets closer, e.g., moves towards the client device 110 or 112; the passing observer 113 lingers, e.g., remains still in the specified vicinity of the client device 110 or 112; or the passing observer 113 acknowledges the targeted content, e.g., moves more slowly away from the client device 110 or 112. The content selector module and the observer reaction module are discussed further below with respect to FIGS. 3A-3C. The client device 110 or 112 may be configured to ignore sensor data regarding other detected passing observers during the time that it is engaged in attempting to attract the attention of the passing observer 113.

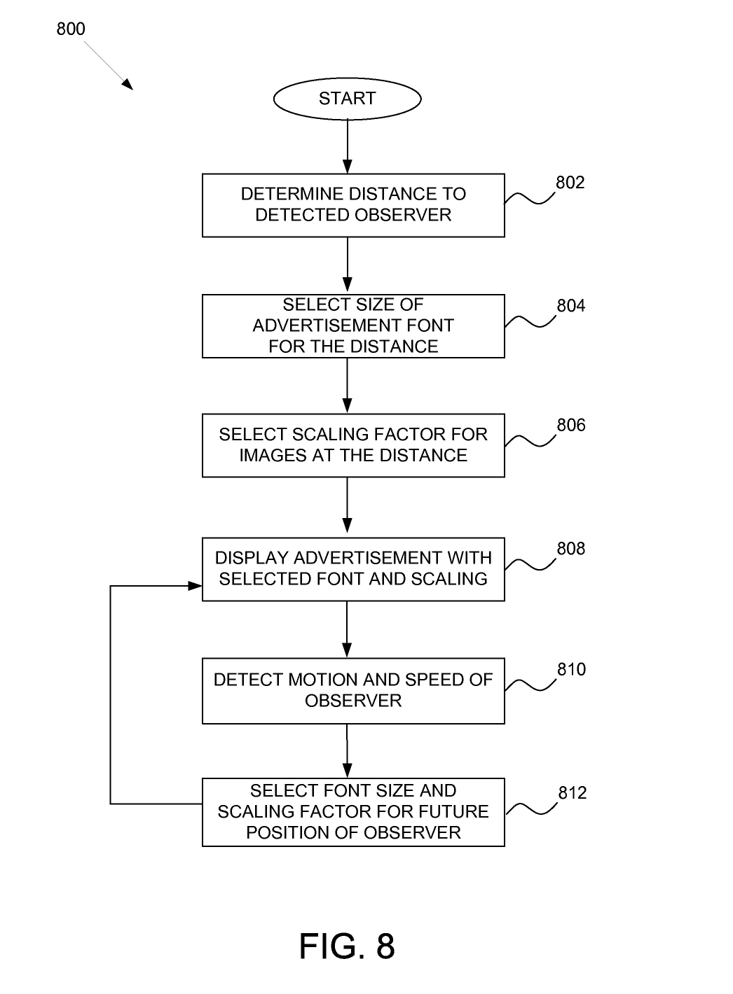

In example embodiments, the client device 112 may be a kiosk and the client device 110 may be a billboard, each used for displaying advertisements designed to attract customers such as passing observer 113. The kiosk client device 112 may be instructed by the content selector module to publish first targeted content (e.g., a standard advertisement such as a greeting) based on a first detected position of the passing observer 113, e.g., if the passing observer 113 is detected within a specified vicinity of the kiosk such as a few feet away. The kiosk client device 112 may be instructed by the content selector module to publish second more aggressive targeted content including flashing images and sounds (such as an invitation to a sale) based on a determination (e.g., by the observer reaction module) that the first kiosk advertisement did not cause a reaction from the passing observer 113. The second kiosk advertisement may be a more detailed advertisement including options for interacting with the kiosk client device 112 (e.g., shopping or messaging) based on a determination that the first kiosk advertisement did cause a reaction from the passing observer 113. The kiosk client device 112 may include a user interface (e.g., touch screen) for interacting with passing observer 113 in regards to options that are provided or a connection (e.g., wireless) to a mobile device (like the device of FIG. 8) of passing observer 113 may be used for this purpose.

During operation, client device 112 uses motion sensing technology (e.g., electromagnetic radiation, such as infrared light, and/or sound, such as ultrasound, etc.) to detect passing observer 113 within a specified vicinity of client device 112. Once passing observer 113 is detected, the client device 112 emits a greeting, such as “Welcome!” together with music or other sounds and displays video or images large enough to be understood from the detected distance of the passing observer 113. If the passing observer 113 is beyond the specified vicinity of client device 112 then the passing observer 113 is not detected and therefore the client device 112 does not publish any targeted content. Furthermore, the client device 112 may be configured to emit sounds when passing observer 113 is detected only when other conditions are present, for example, the position of passing observer 113, whether passing observer 113 just passed the client device 112, and/or whether the passing observer 113 has been shopping near the client device 112 for a specified period of time. The specified vicinity around client device 112 (or 110) may be shaped so as to not sense local workers or other regular visitors that usually stay within certain areas (e.g. a local store) that might otherwise be included in the specified vicinity in which client device 112 detects passing observer 113. In this way, the client device 112 does not continually sense potential customers and therefore does not continuously emit sounds, which would annoy and possibly alienate passing observer 113.

In an embodiment, the client device 110 comprises a billboard and the content selector module instructs client device 110 to display a first billboard advertisement (e.g., advertisement with a small number of large images and/or text) based on a first detected position of the passing observer 113 (e.g., if the passing observer 113 is detected driving a car beyond a threshold distance from the billboard) and to display a second billboard advertisement that provides more details (e.g., advertisement with a larger number of smaller images and/or text) based on a second detected position of the passing observer 113 that is closer to the client device 110 (e.g., if the passing observer 113 is detected driving a car within the threshold distance from the billboard) than the first detected position of the passing observer 113.

In an embodiment, the threshold distance from the client device 110 may be based on the ability of a standard human being (e.g., passing observer 113) to discern images and text at certain distances. For example, the first billboard advertisement may include larger images and text to attract the passing observer 113 at a distance and the second billboard advertisement can provide more details by making use of more numerous smaller images and text that are too small to be understood/discerned from the first detected position of the passing observer 113 but large enough to be understood/discerned from the second position of the passing observer 113.

FIGS. 2 and 3 illustrate the publication system 120 and the interaction system 122 that work together with the client devices 110 and 112 interact with passing observer 113.

FIG. 2 is a block diagram illustrating multiple components that, in one embodiment, are provided within the publication system 120 of the networked system 102. In one embodiment, the publication system 120 is a marketplace system where items may be offered for sale, e.g., via advertisements displayed by client device 110 or 112. The publication system 120 may be hosted on dedicated or shared server machines (e.g., application server(s) 118) that are communicatively coupled to enable communications between the server machines. The multiple components themselves are communicatively coupled (e.g., via appropriate interfaces), either directly or indirectly, to each other and to various data sources, to allow information to be passed between the components or to allow the components to share and access common data. Furthermore, the components may access the one or more databases 126 via the one or more database servers 124.

In one embodiment, the publication system 120 provides a number of publishing, listing, and price-setting mechanisms whereby a seller may advertise goods or services for sale (or provide images and other information that may be used for advertisements), a buyer (e.g., passing observer 113) can express interest in or indicate a desire to purchase such goods or services (e.g., via a selection made at a user interface of a client device 110 or 112), and a price can be set for a transaction pertaining to the goods or services. To this end, the publication system 120 may comprise at least one publication engine 202 and one or more shopping engines 204.

A pricing engine 206 supports various price listing formats such as a fixed-price listing format (e.g., the traditional classified advertisement-type listing or a catalog listing). A store engine 208 allows a seller (e.g., vendor) to group listings within a “virtual” store, which may be branded and otherwise personalized by and for the seller for presentation to a viewer via the client devices 110 and 112. Such a virtual store may also offer promotions, incentives, and features that are specific and personalized to the seller.

Navigation of the publication system 120 (e.g., via a user interface of a client device 110 or 112) may be facilitated by a navigation engine 210. For example, a search module (not shown) of the navigation engine 210 enables, for example, keyword searches of vendors, listings or other information published via the publication system 120. In a further example, a browse module (not shown) of the navigation engine 210 allows users to browse various category, catalog, or data structures according to which listings or other information may be classified within the publication system 120. In one embodiment, the navigation engine 210 may navigate (e.g., conduct a search on) a network at large (e.g., network 104).

In order to make listings or posting of information (e.g., advertisements) available via the networked system 102 as visually informing and attractive as possible, the publication system 120 may include an imaging engine 212 that enables users to upload images, including 3D images, for inclusion within listings and advertisements. In some embodiments, the imaging engine 212 also receives image data from vendors and utilizes the image data to generate respective vendor advertisements and/or interfaces for user interaction. The imaging engine 212 may work in conjunction with the interaction system 122 to generate a vendor interface for integration within the advertisements and listings displayed for a specific vendor.

A listing engine 214 manages listings on the publication system 120. In example embodiments, the listing engine 214 allows users to author listings of items. The listing may comprise an image of an item along with a description of the item. In one embodiment, the listings pertain to goods or services that a user (e.g., a vendor) wishes to transact via the publication system 120. As such, the listing may comprise an image of a good for sale and a description of the item such as, for example, dimensions, color, and, identifier (e.g., UPC code, ISBN code). In some embodiments, a user may create a listing that is an advertisement or other form of publication to the networked system 102. The listing engine 214 also allows the users to manage such listings by providing various management features (e.g., auto-relisting, inventory level monitors, etc.).

A messaging engine 216 is responsible for the generation and delivery of messages to users (e.g., via client devices of the users) of the networked system 102. Such messages include, for example, advising users regarding the status of listings and purchases (e.g., providing an acceptance notice to a buyer) or providing recommendations. The messaging engine 216 may utilize any one of a number of message delivery networks and platforms to deliver messages to users. For example, the messaging engine 222 may deliver electronic mail (e-mail), an instant message (IM), a Short Message Service (SMS), text, facsimile, or voice (e.g., Voice over IP (VoIP)) messages via wired networks (e.g., the Internet), a Plain Old Telephone Service (POTS) network, or wireless networks (e.g., mobile, cellular, WiFi, WiMAX, etc.).

An interaction system 122 manages the generation of a vendor interface for integration into an advertisement or listing of a specific vendor. The interaction system 122 is shown as part of the publication system 120 but could be included in the client device 110 or 112.

Although the various components of the publication system 120 have been defined in terms of a variety of individual modules and engines, a skilled artisan will recognize that many of the items can be combined or organized in other ways. Alternatively, not all components of the publication system 120 of FIG. 2 may be utilized. Furthermore, not all components of the marketplace system 120 have been included in FIG. 2. In general, components, protocols, structures, and techniques not directly related to functions of exemplary embodiments (e.g., dispute resolution engine, loyalty promotion engine, personalization engines, etc.) have not been shown or discussed in detail. The description given herein simply provides a variety of exemplary embodiments to aid the reader in an understanding of the systems and methods used herein.

FIG. 3 is a block diagram illustrating multiple components that, in one embodiment, are provided within an interaction system 122 operable over network 104.

The interaction system 122 comprises a distance module 300, a speed module 304, an object recognition module 04, a detection module 306, a save module 308, A content selector module 310, a recommendation module 312, an observer reaction module 314, a purchase module 316 and a scaling module 318. In alternative embodiments, functions of one or more of the modules of the interaction system 122 may be combined together, one or more of the modules may be removed from the interaction system 122, or one or more of the modules may be located elsewhere in the networked system 102 (e.g., the imaging engine 214, shopping engines 204) or at the client device 110 or 112.

The distance module 300 determines a distance to passing observer 113 using the motion/speed sensors of client device 110 or 112 or using an image received from at least one video camera of client device 110 or 112. For example, the dimensions of objects depicted in the image may be analyzed to determine the distance between the passing observer 113 and the client device 110 or 112.

The speed module 302 determines a speed to passing observer 113 using data received from the motion/speed sensors of client device 110 or 112.

The object recognition module 304 visually searches images provided by a video camera of client device 110 or 112 in order to find and identify objects in the photograph. This may be accomplished via known object recognition techniques such as edge matching, greyscale matching, large model bases, gradient matching, etc. The object recognition module 304 then compares each recognized object against the specified object criteria to determine if object criteria associated with a particular photo filter has been satisfied and, if so, may provide tailored options for interaction between passing observer 113 and client device 110 or 112. The object criteria may include associations between a recognized object and an advertisement that may be displayed by client device 110 or 112.

The detection module 306 detects the position of passing observer 113 relative to client device 110 or 112 using motion and/or speed sensing technology (e.g., electromagnetic radiation, such as infrared light, and/or sound, such as ultrasound, etc.). The detection module 306 may also determine (e.g., via interaction with distance module 300) whether the position of passing observer 113 is within a specified vicinity of client device 110 or 112.

The save module 308 saves visual media images for later use. In one embodiment, the visual media images may be stored to the database 126 of the networked environment 102. Alternatively, the visual media images may be stored to the client device 110 or 112. For example, passing observer 113 may upload a review of a purchased product at a user interface of client device 110 or 112 and this review (possibly including images of the passing observer 113 enjoying the reviewed product) may later be used as part of an advertisement displayed by client device 110 or 112 for said product.

The content selector module 310 determines which advertisements are displayed by client device 110 or 112 based on data from other modules, such as the distance module 300, the speed module 302, the object recognition module 304, the detection module 306 and the observer reaction module 314. For example, the content selector module 310 may select an advertisement for display by the client device 110 or 112 based on the detected position of the passing observer 113. If the passing observer 113 is detected at a first position outside of a threshold distance (e.g., 3 feet) from the advertisement, then an attention grabbing advertisement (e.g., an audio/visual greeting or invitation) may be displayed by the client device 110 or 112. If the passing observer 113 is detected at a closer second position (e.g., inside of the threshold distance from the advertisement), then a more detailed advertisement is displayed by the client device 110 or 112 for interaction with a seemingly interested passing observer 113.

The recommendation module 312 optionally provides recommendations for alternative items (or types of items) for which vendors may be available when the passing observer 113 is interacting with client device 110 or 112, e.g., via a user interface of the client device 110 or 112. For example, if passing observer 113 looks for a smaller sized item of a certain item type (e.g., via navigation engine 210) and is unable to find any, then (e.g., as determined by the navigation engine 210), the recommendation module 312 may suggest one or more alternative items that are smaller and may entice passing observer 113 to make a purchase. The recommendation module 312 may then retrieve the vendor data for vendors of that type of item (e.g., from database(s) 126) and provide the alternative vendors and/or specific items as a suggestion to the passing observer 113.

The purchase module 316 allows passing observer 113 to purchase an item from a vendor for which a vendor interface has been made available via a user interface of client device 110 or 112 or an alternative item has been recommended by the recommendation module 312. In one embodiment, the purchase module 316 provides a purchase interface option (e.g., button) on or near the vendor image (e.g., listing or advertisement) that when used in regard to an item of the vendor takes passing observer 113 to, for example, a purchase page for the item, a store front for a store of the vendor that sells the item, or search page with search results for availability of the item for purchase if no known vendor is available. The purchase module 316 performs the corresponding actions to facilitate the purchase (e.g., send a search for the item to the navigation engine 210, provide one or more listings using the shopping engine 204, provide a webpage associated with the store engine 208).

The scaling module 306 scales images to be used in advertisements displayed via the client device 110 or 112 based on the distance and sizing determined by the distance module 302 and the sizing module 304, respectively. Accordingly, the scaling module 306 may receive (e.g., from the navigation engine 210) or retrieve (e.g., from the database(s) 126) image data for vendors of items of a selected item type. The image data may include a vendor image, item images, dimensions, or item identifiers. Once the item image is scaled, the scaled item image may be included in advertisements displayed via the client device 110 or 112.

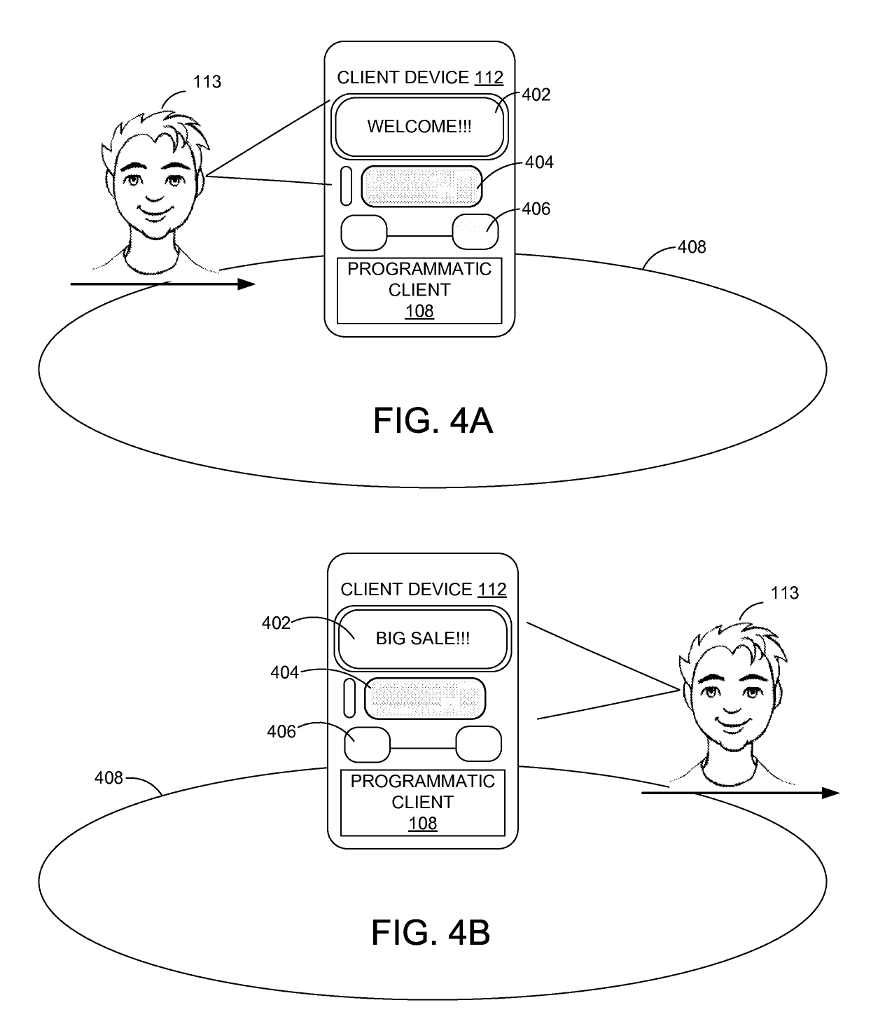

FIGS. 4A and 4B illustrate an example embodiment of client device 112 comprising a kiosk attempting to grab the attention of passing observer 113. The client device 112 may be advantageously placed where a passing observer 113 may view client device 112 in an open environment such as a shop, lobby, a plaza or a mall that is visible to large amounts of human traffic. In the embodiment of FIGS. 4A and 4B, client device 112 includes an electronic display 402 and speakers 406 for publishing targeted content; a user interface 224 for interacting with passing observer 113; and motion sensors and/or speed sensors to detect a position and/or speed of passing observer 113 in specified vicinity 408 of the client device 112.

During operation, client device 112 uses motion sensing technology (e.g., electromagnetic radiation, such as infrared light, and/or sound, such as ultrasound, etc.) to detect passing observer 113 within a specified vicinity 408 of client device 112. If the passing observer 113 is beyond the specified vicinity 408 of client device 112 then the passing observer 113 is not detected and therefore the client device 112 does not publish any targeted content. The specified vicinity 408 around client device 112 may be shaped so as to not sense certain areas (e.g., behind client device 112) or shaped to not sense local workers or other regular visitors that usually stay within certain areas (e.g. a local store) that might otherwise be included in the specified vicinity 408 in which client device 112 detects passing observer 113. In this way, the client device 112 does not continually sense potential customers and therefore does not continuously emit sounds, which would annoy and possibly alienate passing observer 113.

In FIG. 4A, the content selector module 310 (e.g., located at the client device 112 or remotely connected from the interaction system 122) selects first targeted content for publication by the client device 112 based on the detected position of the passing observer 113 within specified vicinity 408 of client device 112. Because the passing observer 113 is detected at a position outside of a threshold distance (e.g., 3 feet) from the client device 112 (but still in specified vicinity 408), attention grabbing first targeted content (e.g., an audio/visual greeting or invitation like “WELCOME!!!”) may be published by the client device 112. If the passing observer 113 is detected at a closer position (e.g., inside of the threshold distance from the advertisement), then more detailed first targeted content could be published by the client device 112 for interaction with a seemingly interested passing observer 113.

The observer reaction module 314 (e.g., located at the client device 112 or remotely connected from the interaction system 122) then determines whether the selected attention grabbing advertisement has caused a reaction by the passing observer 113 (e.g., grabbed the attention of passing observer 113) based on data from the motion sensor and/or the speed sensor of the client device 112. The possible determined reactions might include: the passing observer 113 gets closer, e.g., moves towards the client device 112; the passing observer 113 lingers, e.g., remains still in the specified vicinity of the client device 112; or the passing observer 113 acknowledges the advertisement, e.g., moves more slowly away from the client device 112. The client device 112 may be configured to ignore sensor data regarding other detected passing observers during the time that it is engaged in attempting to attract the attention of the passing observer 113.

In the example of FIG. 4B, the client device 112 is instructed by the content selector module 310 to publish more aggressive second targeted content including flashing images and more inviting sounds (such as an invitation to a “BIG SALE!!!”) based on a determination (e.g., by the observer reaction module 314) that the first targeted content did not cause a reaction from the passing observer 113 (e.g., the passing observer 113 continued to move past client device 112 at a constant or increasing speed). The aggressiveness of this second targeted content can be controlled according to multiple parameters. The volume level of the speakers 226 can be raised to get the attention of passing observer 113. Increasing the speed and/or brightness of flashing lights on display 222 can also increase the chance of catching the attention of passing observer 113. Another parameter can be the time of day, so that multiple time periods based on different anticipated traffic patterns in the vicinity 228 at different times of a day, and to tune the aggressiveness of the advertisements differently for different time periods. Another parameter might be the language of images and sounds in published targeted content, which can be set to vary between popular languages in designated areas.

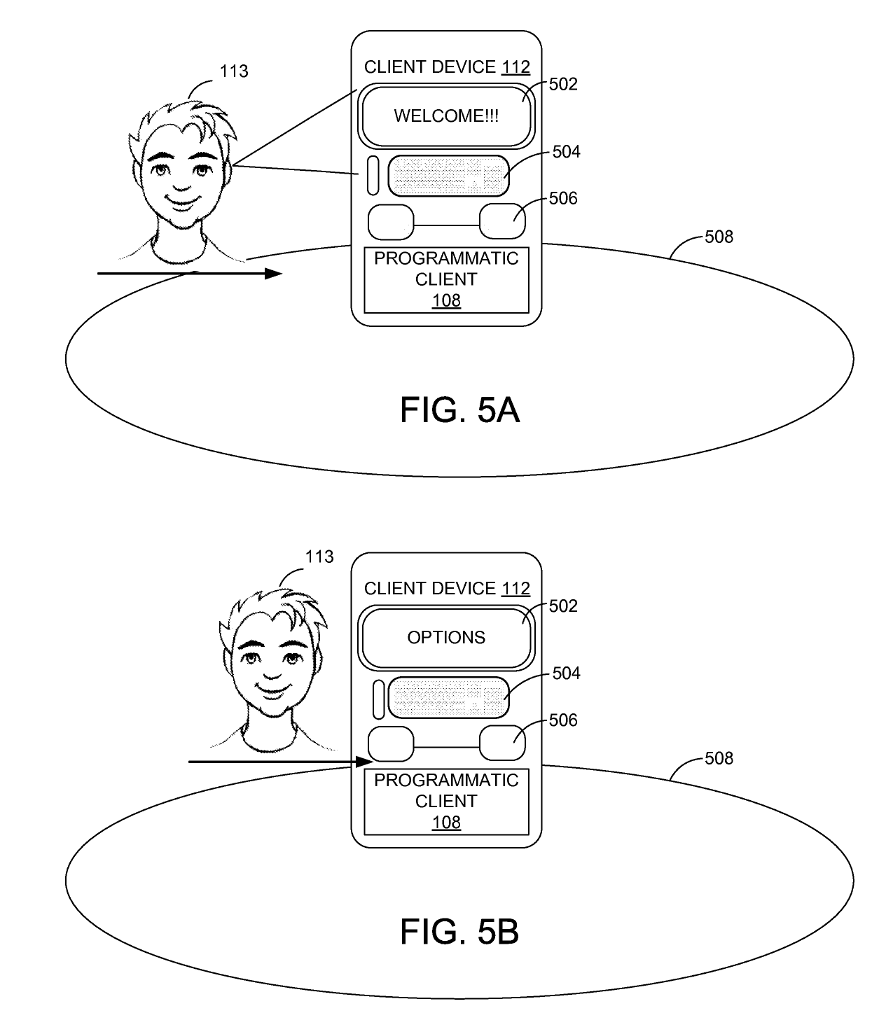

FIGS. 5A and 5B illustrate an example embodiment of client device 112 comprising a kiosk attempting to grab the attention of passing observer 113. As in FIGS. 4A and 4B, client device 112 uses motion sensing technology (e.g., electromagnetic radiation, such as infrared light, and/or sound, such as ultrasound, etc.) to detect passing observer 113 within a specified vicinity 408 of client device 112. If the passing observer 113 is beyond the specified vicinity 408 of client device 112 then the passing observer 113 is not detected and therefore the client device 112 does not publish any targeted content. The specified vicinity 408 around client device 112 may be shaped so as to not sense certain areas (e.g., behind client device 112) or shaped to not sense local workers or other regular visitors that usually stay within certain areas (e.g. a local store) that might otherwise be included in the specified vicinity 408 in which client device 112 detects passing observer 113. In this way, the client device 112 does not continually sense potential customers and therefore does not continuously emit sounds, which would annoy and possibly alienate passing observer 113.

In FIG. 5A, the content selector module 310 (e.g., located at the client device 112 or remotely connected from the interaction system 122) selects first targeted content for publication by the client device 112 based on the detected position of the passing observer 113 within specified vicinity 408 of client device 112. Because the passing observer 113 is detected at a position outside of a threshold distance (e.g., 3 feet) from the client device 112 (but still in specified vicinity 408), attention grabbing first targeted content (e.g., an audio/visual greeting or invitation like “WELCOME!!!”) may be published by the client device 112.

The observer reaction module 314 (e.g., located at the client device 112 or remotely connected from the interaction system 122) then that the selected attention grabbing advertisement has caused a reaction by the passing observer 113 (e.g., grabbed the attention of passing observer 113) based on data from the motion sensor and/or the speed sensor of the client device 112. In this case (as shown in FIG. 4B) passing observer 113 has gotten closer after the first targeted content was published, e.g., passing observer 113 has moved towards the client device 112.

In the example of FIG. 5B, the client device 112 is instructed by the content selector module 310 to publish more detailed second targeted content including options for interacting with the kiosk client device 112 (e.g., shopping or messaging) based on a determination (e.g., by observer reaction module 314) that the first targeted content did cause a reaction from the passing observer 113 (e.g., passing observer 113 came closer). The client device 112 may include a user interface 504 (e.g., touch screen) for interacting with passing observer 113 in regards to options that are provided (e.g., shopping or messaging) or the client device 112 may provide a connection (e.g., wireless) to a mobile device (like the device of FIG. 8) of passing observer 113 for this purpose. The options available to passing observer 113 via client device 112 may be based on objects recognized in a view of the specified vicinity 508 provided by a video camera of client device 112.

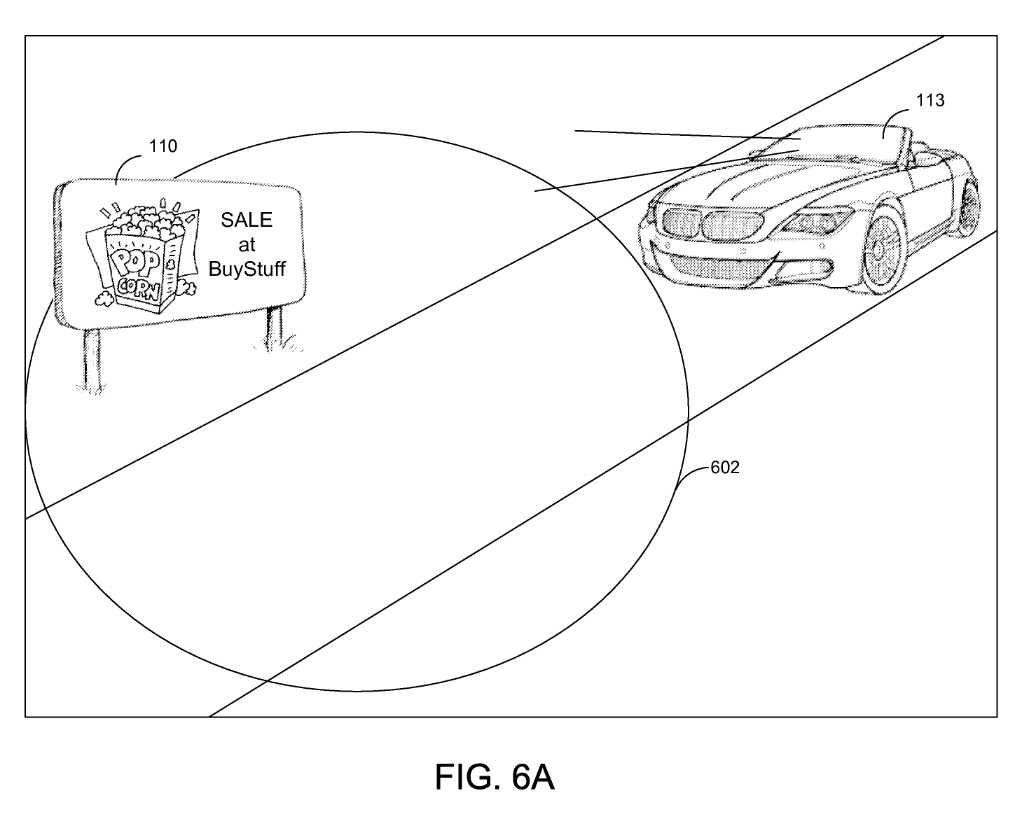

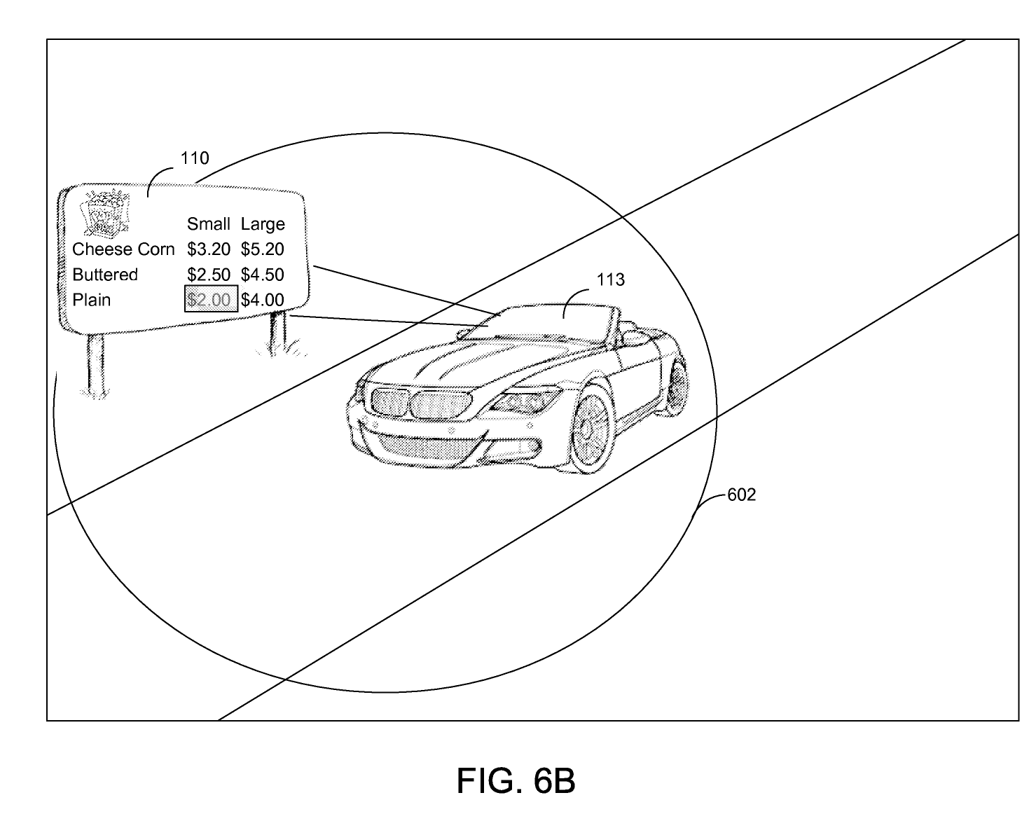

FIGS. 6A and 6B illustrate an example embodiment of client device 110 comprising a billboard attempting to grab the attention of passing observer 113 driving past in an automobile. In FIG. 6A, the client device 110 is instructed by the content selector module 310 to display a first billboard advertisement with a small number of large images (e.g., popcorn bag) and/or text (e.g., “SALE”) based on a first detected position of the passing observer 113 beyond a threshold distance 602 from the client device 110. In FIG. 6B, the client device 110 is instructed by the content selector module 310 to display a second billboard advertisement that provides more details by using a larger number of smaller images (e.g., scaled down popcorn bag) and/or text (types, sizes and prices for popcorn) based on a second detected position of the passing observer 113 that is closer to the client device 110 (e.g., if the passing observer 113 is detected driving a car within the threshold distance 602 from the billboard) than the first detected position of the passing observer 113. In the example, of FIG. 6B even though more details are being shown, this does not mean that attention grabbing elements may not also be combined into the advertisement. For example, visual elements may be used to emphasize certain types or sizes of popcorn such as highlighting the price of small plain popcorn in FIG. 6B.

In an embodiment, the threshold distance 602 from the client device 110 may be based on the ability of a standard human being (e.g., passing observer 113) to discern images and text at certain distances. For example, the first billboard advertisement of FIG. 6A includes larger images and text to attract the passing observer 113 at a distance and the second billboard advertisement of FIG. 6B can provide more details by making use of more numerous smaller images and text that are too small to be understood/discerned from the first detected position of the passing observer 113 (e.g., outside of threshold distance 602) but large enough to be understood/discerned from the second position of the passing observer 113 (e.g., inside of threshold distance 602). The content selector module 310 may use speed data for passing observer 113 in order to predict a future position of passing observer 113 and use this information to instruct client device 110 to change the first displayed advertisement to the second advertisement in anticipation of the predicted future position of passing observer 113.

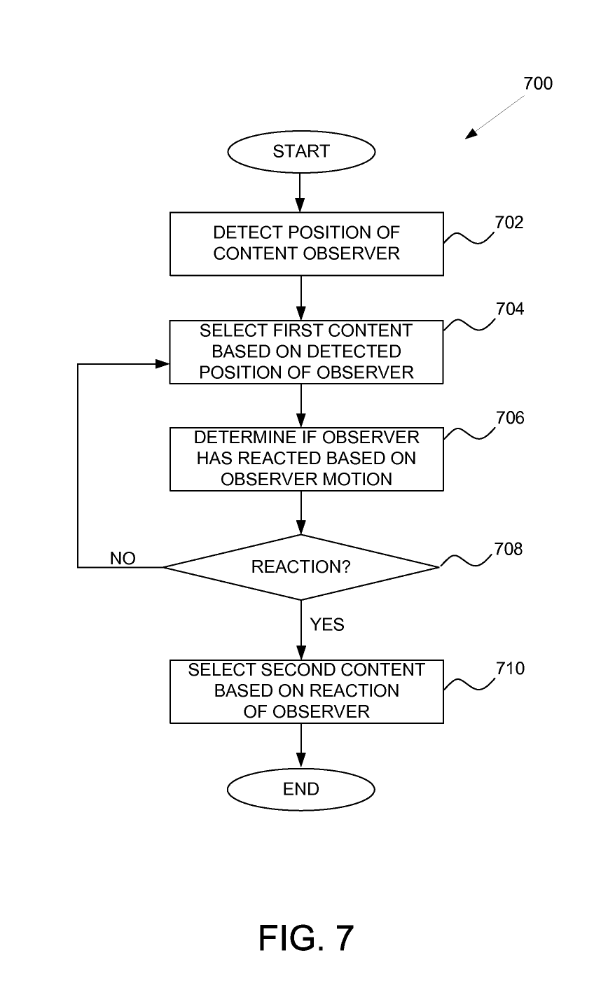

FIG. 7 is a flow diagram of an example high-level method for interaction between a content publication device and a passing observer in an open public viewing/listening environment. In operation 702, a content publication device in the form of client device 112 (or 110) uses motion sensors and/or speed sensors to detect a position and/or speed of passing observer 113 in specified vicinity 408 of the client device 112. In operation 704, the content selector module 310 (e.g., located at the client device 112 or remotely connected from the interaction system 122) selects first targeted content for publication by the client device 112 based on the detected position of the passing observer 113. For example, if the passing observer 113 is detected at a first position outside of a threshold distance (e.g., 3 feet) from the client device 112, then attention grabbing targeted content (e.g., an audio/visual greeting or invitation) may be published by the client device 112. If the passing observer 113 is detected at a closer second position (e.g., inside of the threshold distance from the advertisement), then more detailed first targeted content is published by the client device 112 for interaction with a seemingly interested passing observer 113.

At operation 708, the observer reaction module 314 (e.g., located at the client device 112 or remotely connected from the interaction system 122) determines whether the first targeted content has caused a reaction by the passing observer 113 (e.g., grabbed the attention of passing observer 113) based on data from the motion sensor and/or the speed sensor of the client device 112. The possible determined reactions might include: the passing observer 113 gets closer, e.g., moves towards the client device 112; the passing observer 113 lingers, e.g., remains still in specified vicinity 408 of the client device 112; or the passing observer 113 acknowledges the targeted content, e.g., moves more slowly away from the client device 112. If a reaction by passing observer 113 is not detected, then the method returns to operation 704 so that, if the passing observer is still detected in specified vicinity 408, the content selector module 310 can select more aggressive second targeted content for display by the client device 112 in order to grab the attention of passing observer 113. As explained above more aggressive targeted content (e.g., advertisements) may include louder sounds and brighter images designed to attract passing observer 113 or the more aggressive targeted content may include more substantive offers such as special sales, coupons or other discounts available via client device 112. If a reaction by passing observer 113 is detected, then the method continues to operation 710 so that the content selector module 310 can select more detailed second targeted content for publication by the client device 112 in order to provide interaction options for of passing observer 113, e.g., via a user interface of client device 112. As explained above the more detailed targeted content (e.g., advertisements) may include shopping opportunities including payment processing capabilities designed to facilitate commercial transactions by passing observer 113 or the more detailed advertisement may opportunities for exploring local vendor offerings, for exploring local maps or for messaging with local businesses or other entities.

FIG. 8 is a flow diagram of an example high-level method for interaction between a content publication device and a passing observer in an open public viewing/listening environment. In operation 802, a distance between passing observer 113 and client device 110 (or 112) is determined by the distance module 302. The distance module 302 may use motion sensors, speed sensors, cameras or any other sensors of client device 110 to determine the distance. In operation 804, sizing for the fonts used in an advertisement to be displayed by client device 110 is be selected based on the detected distance to passing observer 113 from client deice 110. The fonts may be selected based on the ability of a standard human to understand text of a specified font size at the determined distance of passing observer 113. In operation 806, a scaling factor is selected for each image to be used in an advertisement to be displayed by client device 110 is be selected based on the detected distance to passing observer 113 from client deice 110. The scaling factor (e.g., twice as large, half as large or any other factor) may be selected based on the ability of a standard human to understand the scaled image at the determined distance of passing observer 113.

In operation 808, the advertisement is displayed by client device 110 using the selected fonts and the selected scaling factor for images in the advertisement. In operation 810, the content selector module 310 may obtain motion and speed data for passing observer 113 from motion and speed sensors of client device 110. In operation 812, the content selector module 310 may use the motion and speed data for passing observer 113 in order to predict a future position of passing observer 113 and use this information to select font sizes and scaling factors to be used in any advertisement displayed when passing observer 113 is at the predicted future position. The method then returns to operation 808 (e.g., at the time that passing observer 113 is expected to be at the predicted position), so that the advertisement can be displayed by client device 110 using the fonts and scaling factors selected for the predicted position of passing observer 113 in operation 812 for images in the advertisement.

Additionally, certain embodiments described herein may be implemented as logic or a number of modules, engines, components, or mechanisms. A module, engine, logic, component, or mechanism (collectively referred to as a “module”) may be a tangible unit capable of performing certain operations and configured or arranged in a certain manner. In certain example embodiments, one or more computer systems (e.g., a standalone, client, or server computer system) or one or more components of a computer system (e.g., a processor or a group of processors) may be configured by software (e.g., an application or application portion) or firmware (note that software and firmware can generally be used interchangeably herein as is known by a skilled artisan) as a module that operates to perform certain operations described herein.

In various embodiments, a module may be implemented mechanically or electronically. For example, a module may comprise dedicated circuitry or logic that is permanently configured (e.g., within a special-purpose processor, application specific integrated circuit (ASIC), or array) to perform certain operations. A module may also comprise programmable logic or circuitry (e.g., as encompassed within a general-purpose processor or other programmable processor) that is temporarily configured by software or firmware to perform certain operations. It will be appreciated that a decision to implement a module mechanically, in dedicated and permanently configured circuitry, or in temporarily configured circuitry (e.g., configured by software) may be driven by, for example, cost, time, energy-usage, and package size considerations.

Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules or components are temporarily configured (e.g., programmed), each of the modules or components need not be configured or instantiated at any one instance in time. For example, where the modules or components comprise a general-purpose processor configured using software, the general-purpose processor may be configured as respective different modules at different times. Software may accordingly configure the processor to constitute a particular module at one instance of time and to constitute a different module at a different instance of time.

Modules can provide information to, and receive information from, other modules. Accordingly, the described modules may be regarded as being communicatively coupled. Where multiples of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices and can operate on a resource (e.g., a collection of information).

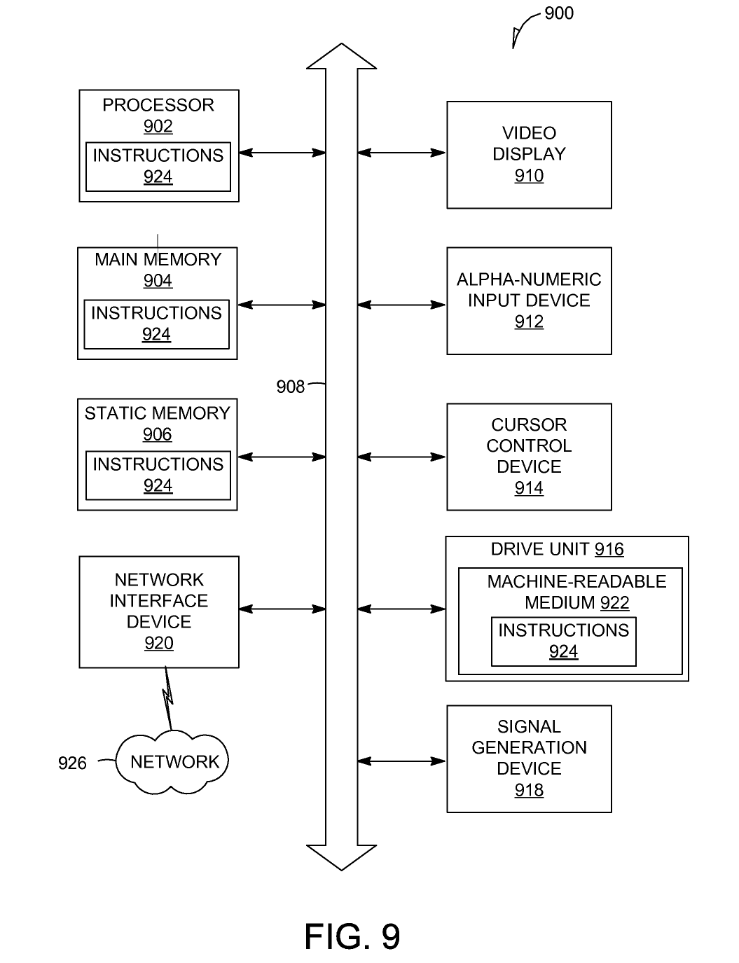

With reference to FIG. 9, an example embodiment extends to a machine in the example form of a computer system 900 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, a switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 may include a processor 902 (e.g., a central processing unit (CPU), a graphics processing unit (GPU) or both), a main memory 904 and a static memory 906, which communicate with each other via a bus 908. The computer system 900 may further include a video display unit 910 (e.g., a liquid crystal display (LCD) or a cathode ray tube (CRT)). In example embodiments, the computer system 900 also includes one or more of an alpha-numeric input device 912 (e.g., a keyboard), a user interface (UI) navigation device or cursor control device 914 (e.g., a mouse), a disk drive unit 916, a signal generation device 918 (e.g., speaker), and a network interface device 920.

The disk drive unit 916 includes a machine-readable storage medium 922 on which is stored one or more sets of instructions 924 and data structures (e.g., software instructions) embodying or used by any one or more of the methodologies or functions described herein. The instructions 924 may also reside, completely or at least partially, within the main memory 904 or within the processor 902 during execution thereof by the computer system 900, with the main memory 904 and the processor 902 also constituting machine-readable media.

While the machine-readable storage medium 922 is shown in an example embodiment to be a single medium, the term “machine-readable storage medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media. Specific examples of machine-readable storage media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 924 may further be transmitted or received over a communications network 926 using a transmission medium via the network interface device 920 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other medium to facilitate exchange of software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

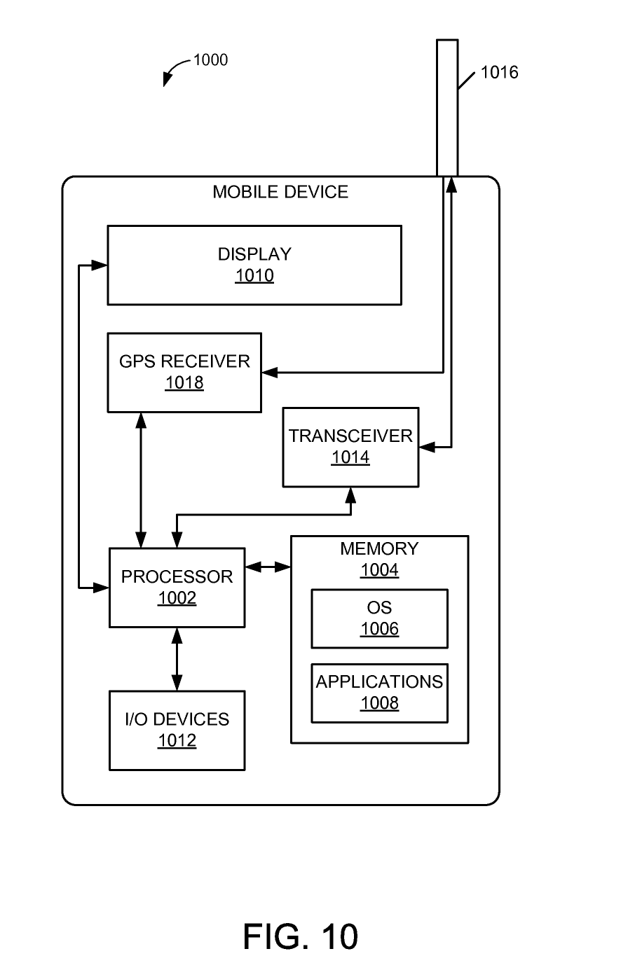

FIG. 10 is a block diagram illustrating a mobile device 1000, according to an example embodiment. The mobile device 1000 can include a processor 1002. The processor 1002 can be any of a variety of different types of commercially available processors suitable for mobile devices (for example, an XScale architecture microprocessor, a Microprocessor without Interlocked Pipeline Stages (MIPS) architecture processor, or another type of processor). A memory 1004, such as a Random Access Memory (RAM), a Flash memory, or another type of memory, can be accessible to the processor. The memory 1004 can be adapted to store an operating system (OS) 1006, as well as application programs 1008, such as a mobile location enabled application that can provide LBS to a user.

The processor 1002 can be coupled, either directly or via appropriate intermediary hardware, to a display 1010 and to one or more input/output (I/O) devices 1012, such as a keypad, a touch panel sensor, a microphone, and the like. Similarly, in some embodiments, the processor 1002 can be coupled to a transceiver 1014 that interfaces with an antenna 1016. The transceiver 1014 can be configured to both transmit and receive cellular network signals, wireless data signals, or other types of signals via the antenna 1016, depending on the nature of the mobile device 1000. Further, in some configurations, a GPS receiver 1018 can also make use of the antenna 1016 to receive GPS signals.

1. A system comprising:
a content publication device including a display module for displaying targeted content in or on an interface to a passing observer;
at least one motion sensor module for compiling motion data relating to a passing observer; and
an observer interaction engine including:
at least one processor;
a detection module configured to detect a first position of the passing observer relative to the interface based at least on motion data received from the at least one motion sensor module;
a content selector module configured to select first targeted content for display by the content display device based on the first detected position of the passing observer; and
an observer reaction module configured to determine whether the first targeted content displayed to the passing observer has caused a reaction in the passing observer based at least on the motion data.

2. The system of claim 1, wherein the reaction comprises the passing observer moving towards the interface or the passing observer remaining still in a specified vicinity of the interface.

3. The system of claim 2, wherein:
the content publication device further comprises at least one speed sensor to measure a speed of the passing observer;
the reaction comprises the passing observer moving more slowly away from the interface; and
the observer reaction module is further configured to determine whether the first targeted content has caused a reaction based on the speed of the passing observer.

4. The system of claim 3, wherein the content publication device comprises a kiosk and the content selector module is further configured to select second targeted content including flashing images and sounds for display by the content display device based on a determination that the first targeted content did not cause a reaction.

5. The system of claim 3, wherein the content publication device comprises a kiosk and the content selector module is further configured to select second targeted content providing options for interacting with the content publication device for display by the content display device based on a determination that the first targeted content did cause a reaction.

6. The system of claim 5, wherein the options provided by the second targeted content include shopping options, messaging options or option for viewing local maps.

7. The system of claim 6, wherein the content publication device further comprises at least one video camera to view the specified vicinity and the options provided by the second targeted content are based on object recognition in a view of the specified vicinity.

8. The system of claim 1, wherein the content publication device comprises a billboard and the content selector module is further configured to select second targeted content that provides more details than the first targeted content for display by the content publication device based on a second detected position of the passing observer that is closer to the interface than the first detected position of the passing observer.

9. The system of claim 8, wherein the first targeted content includes larger images and text to attract the passing observer and the second targeted content provides more details than the first targeted content by making use of smaller images and text that are too small to be understood from the first detected position of the passing observer but large enough to be understood from the second detected position of the passing observer.

10. The system of claim 8, the observer interaction engine further comprising a scaling module configured to scale at least one image of the first targeted content or the second targeted content for display by the content publication device based on the first detected position or the second detected position of the passing observer respectively.

11. A method comprising:
detecting a first position of a passing observer relative to a content publication device based on at least motion data from at least one motion sensor of the content publication device;
selecting first targeted content for publication by the content publication device based on the first detected position of the passing observer; and
determining whether the first targeted content has caused a reaction by the passing observer based on at least the motion data.

12. The method of claim 11, wherein the reaction comprises the passing observer moving towards the content publication device or the passing observer remaining still in a specified vicinity of the content publication device.

13. The method of claim 12, wherein the reaction comprises the passing observer moving more slowly away from the content publication device, the method further comprising:
measuring a speed of the passing observer based on at least speed data from at least one speed sensor of the content publication device; and
determining whether the selected targeted content has caused a reaction based on the speed of the passing observer.

14. The method of claim 13, wherein the content publication device comprises a kiosk, the method further comprising selecting second targeted content including flashing images and sounds for publication by the content publication device based on a determination that the first targeted content did not cause a reaction.

15. The method of claim 13, wherein the content publication device comprises a billboard, the method further comprising selecting second targeted content that provides more details than the first targeted content for publication by the content publication device based on a second detected position of the passing observer that is closer to the content publication device than the first detected position of the passing observer.

16. The method of claim 15, wherein the first targeted content includes larger images and text to attract the passing observer and the second targeted content provides more details by making use of smaller images and text that are too small to be understood from the first detected position of the passing observer but large enough to be understood from the second detected position of the passing observer.

17. A non-transitory machine-readable medium storing instructions which, when executed by the at least one processor of a machine, causes the machine to perform operations comprising:
detecting a first position of a passing observer relative to a content publication device based on at least motion data from at least one motion sensor of the content publication device;
selecting first targeted content for publication by the content publication device based on the first detected position of the passing observer; and
determining whether the first targeted content has caused a reaction by the passing observer based on at least the motion data.

18. The non-transitory machine-readable medium of claim 17, wherein the reaction comprises the passing observer moving towards the content publication device or the passing observer remaining still in the specified vicinity of the content publication device.

19. The non-transitory machine-readable medium of claim 17, wherein the reaction comprises the passing observer moving more slowly away from the content publication device, the steps further comprising:
measuring a speed of the passing observer based on at least speed data from at least one speed sensor of the content publication device; and
determining whether the selected targeted content has caused a reaction based on the speed of the passing observer.

20. The non-transitory machine-readable medium of claim 17, wherein the content publication device comprises a kiosk, the steps further comprising selecting second targeted content providing options for interacting with the content publication device for display by the content display device based on a determination that the first targeted content did cause a reaction.
